(19) United States
(12) Patent Application Publication
(10) Pub. No.: US 2003/0077439 A1
(43) Pub. Date: Apr. 24, 2003

(54) Self-adhesive masking tape for vehicles and vehicle parts

(76) Inventors: Ingo Neubert, Norderstedt (DE); Bernhard Mussig, Seevetal (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/190,800

(22) Filed: Jul. 8, 2002

(30) Foreign Application Priority Data
Oct. 20, 2001 (DE) 101 51 818.8

(51) Int. Cl. B32B 7/12; B32B 15/04

(52) U.S. Cl. 428/343; 428/355 R

(57) ABSTRACT

A self-adhesive masking tape for vehicles and vehicle parts, comprising a backing material applied to at least one side of which there is an adhesive coating, wherein said backing material is composed of a material in web form having

an MD tensile force at 1% elongation of at least 4.5 N/cm,

an MD force at an elongation at 10% and 150% of from 12 to 28 N/cm,

an MD tensile strength of from 12 to 30 N/cm, and

an MD elongation at break in the range from 150% to 300%

(MD=machine direction, i.e., longitudinal direction).

The present invention relates to an extensible self-adhesive masking tape which is specially suitable for masking off areas prior to painting, primarily for vehicles such as automobiles or parts such as bumpers, motorbike tanks, etc., and for producing sharp paint edges in the painting process.

Self-adhesive masking tapes, including stencils formed from them, referred below as adhesive masking tapes, have to have a number of key properties in order to meet the particular requirements imposed on them. Easy extensibility when bonding to curves coupled with a high modulus of elasticity in the range of the forces encountered during unwind or during application to straight sections, little if any tendency to shrink in the bonded state, and low thickness are important primary requirements in order for a sharp, even paint edge to be produced on convex surfaces and to allow clean adhesive bonding in curves.

Moreover, the adhesive is required to have a sufficient bond strength, but not too high, so that redetachability without residue can be ensured following use. As well as these properties, coating materials (paints) must adhere well to the reverse of the masking tape. Otherwise, removal of the masking tape after use leads to jagged, uneven paint edges and also to the flaking of the coating materials, and hence to the contamination and damaging of the freshly painted areas.

While some of the properties can be attributed to the adhesive or other functional layers of the adhesive masking tape, extensibility, tensile strength, shrinkage, and paint adhesion are based substantially on the physical properties of the unembellished backing that is used. Extensibility in particular is a vital property of adhesive masking tapes, since it alone allows crease-free blanket bonding in curves and on spherical surfaces, such as is needed, for example, when refinishing automobiles. In manual application, an extensible adhesive masking tape can be made to follow contours perfectly and so leads to a clean paint edge with no underruns.

For this application it has been common to date to use adhesive masking tapes composed of a backing film of PVC, paper, polyester, polyethylene or polypropylene.

Adhesive tapes based on a plasticized PVC (PVCp) film are described, for example, in GB 2,171,712 B. Conventional PVCp adhesive tapes include more than 35 parts by weight of a phthalate-based monomer plasticizer per 100 parts by weight of PVC polymer. Following the application of these PVCp adhesive tapes, however, residues are observed on the paint surface, and are referred to by those skilled in the art, depending on amount, as ghosting or adhesive residues. The ghosting effect can be attributed, for example, to the use of additives of low molecular mass in the PVC backing film or in the adhesive. The use of monomer plasticizers is manifested to a particularly negative effect in this context. Moreover, thermal treatment, such as takes place with the curing of paint films, is accompanied by increased migration into the adhesive of low molecular mass additives such as monomer plasticizers. The consequence is a softening of the adhesive, leading in turn to residues of adhesive on the paint surface, after the masking tape has been removed, when the system is stored at temperatures of 60° C.

A further disadvantage of the PVCp adhesive masking tapes is their inadequate ease of application. Responsible for this disadvantage is the low tensile strength at low film elongation, so that the adhesive masking tape becomes stretched on application. Thermal paint curing is observed to be accompanied by shrinkback of these stretched adhesive masking tapes, leading in turn to residues of adhesive at the ends and to the lifting of the edges from the paint surface. Accordingly, unclean paint edges and underruns develop.

Moreover, the elongation at break and tensile strength of PVCp backing films is normally too high, making tearing of the adhesive masking tape without tools such as scissors or knives very difficult. Easy hand-tearability on application, however, is desirable from the user's standpoint.

Likewise known are adhesive masking tapes composed of a PVC backing material in web form comprising a PVC polymer having a K value of more than 63, generally from 65 to 80, and a mixture of monomer and polymer plasticizer. These tapes give rise to less fogging and fewer residues than the PVC adhesive tapes containing monomer plasticizer alone. These adhesive masking tapes display the tensile elongation properties typical of PVC materials, manifested in a steady increase in tensile strength with increasing elongation. Generally, the elongation at break of these adhesive masking tapes is too low and their tensile strength is too high. Moreover, the force at a lower extension of 1% is below 3 N/cm, so that in the same way as the conventional PVCp adhesive tapes based on monomer plasticizer, the adhesive masking tape becomes stretched on application and therefore tends toward shrinkage and lifting of the edges on heating. Additionally, tearing of these adhesive masking tapes is possible only by applying a high force. This characteristic is reflected in a tensile impact strength of more than 1,100 kJ/m².

For masking in the painting process, adhesive tapes composed of a paper backing material are likewise used. Because of their low extensibility, however, these materials are poorly suited to this application. With the conventional smooth adhesive paper tapes, bonding in convex geometries and around curves is impossible. Because of the low extensibility, adhesive paper tapes tear in use. When more extensive creped adhesive paper tapes are used, on the other hand, the drawback exists that in the painting process the paint runs under the adhesive tape, making it impossible to produce sharp paint edges. Parts made of plastic, such as bumpers, expand considerably during the baking process of the paint at elevated temperatures. Because of their low extensibility, the adhesive paper masking tapes are unable to follow this thermal expansion. The result is residues of adhesive at the ends and in the edge regions.

Likewise in the use in practice are adhesive masking tapes composed of a backing film made of polyester such as polyethylene terephthalate. A feature of these adhesive backing tapes is their very good temperature stability. On the other hand, owing to the very high tensile strength and low extensibility of these backing materials, bonding in convex areas and around curves is not possible. The same applies to adhesive masking tapes based on unplasticized PVC films; in this case, however, a considerable shrinkage tendency is observed at temperatures above 90° C.

Also state of the art are adhesive masking tapes based on a polyolefin backing. Examples of adhesive tapes of this kind are described in WO 00/05305 A1, EP 0 823 467 A1, and EP 0 875 548 A1. Polyolefin adhesive tapes have the advantage over PVC materials that they are in principle free from plasticizers. Consequently, ghosting and residues, induced by the migration of low molecular mass ingredients, are less frequently observed. Under mechanical tensile load, however, the polyolefin films have a fundamental tendency toward lateral constriction, referred to by the skilled worker as necking. This gives polyolefin-based adhesive masking tapes considerable performance disadvantages. In the case of bonding in curves and arcs, and when the adhesive tape is applied with a tensile load above the yield point of the films, which is often the case on application, stretching occurs and, consequently, a lateral constriction of the adhesive masking tape. Necking-free bonding around curves, and thus the production of even paint edges in curve form, is not a possibility. A further disadvantage of application arises from the great tendency of the polyolefin films to exhibit shrinkback on heating. Similarly, the thermal load-bearing capacity of polyolefin adhesive masking tapes is poor. Backing materials based on polypropylene can be used for brief periods at temperatures of not more than 150° C., and those based on polyethylene only to a maximum of 110° C., even. Above these temperatures, the backing materials melt and are therefore unusable. WO 00/05305 A1 attempts to counter the necking by virtue of a polyolefin mixture, by avoiding a yield point. Even here, however, it is impossible to avoid necking, especially at relatively high extensions (from 20 to 50%) such as are likely when bonding around narrow curves and in strongly convex areas. The use of this polyolefin mixture is detrimental to the mechanical properties, especially to the modulus at low extension and to the shrinkback tendency.

On application, the adhesive masking tape becomes excessively extended. The consequence is an increased shrinkage and a lifting of the edges at elevated temperatures. Furthermore, poor paint adhesion to polyolefin films is observed. In the case of the adhesive masking tapes, with polyolefin backing, therefore, there is flaking of the cured paint film. It is impossible to produce a clean, uniform paint edge. Also, with these materials, tearing by hand is possible only by applying a high force. WO 00/05305 A1 aims at a flattened plot in the stress-strain diagram, avoiding the formation of a yield point. In this respect, however, the mechanical behavior is similar to that of conventional PVCp adhesive tapes, and therefore also has the abovementioned disadvantages of low tensile strength at low elongation and an increased shrinkback tendency.

It is an object of the invention to provide an adhesive masking tape comprising a backing material in web form, the extent and nature of the extensibility of the backing material being such that it meets the envisaged requirements to a particularly high extent, featuring a low extension during unwind or application but at the same time an easy extensibility when bonding curves and on convex surfaces.

This object is achieved by means of an adhesive masking tape as specified in the main claim. The subclaims provide advantageous developments of the subject matter of the invention. The invention further embraces possible uses of the adhesive masking tape of the invention.

Surprisingly and unforeseeably for the skilled worker, an adhesive masking tape comprising a backing material having mechanical properties according to the invention is able to meet the contradictory requirements for high force at low elongation coupled with good deformability (moderate force at high elongation) and conformability and so to achieve the stated objects. The backing material has:

an MD tensile force at 1% elongation of at least 4.5 N/cm,

an MD force at an elongation at 10% and 150% of from 12 to 28 N/cm,

an MD tensile strength of from 12 to 30 N/cm, and

an MD elongation at break in the range from 150% to 300%

(MD=machine direction, i.e., longitudinal direction).

Characteristic variables of the backing material for the purposes of the present invention are elongation at break and ultimate tensile force. They are normally determined at the end point of the stress-strain diagram in the tensile testing of a test strip and are reported in percent relative to the original length and/or in N/cm (DIN EN ISO 527-3). A balanced MD tensile strength in the range from 12 to 30 N/cm permits easy tearing by hand. A force of from 12 to 28 N/cm at an extension of between 10% and 150% permits crease-free curve bonding of the adhesive masking tapes and planar bonding on spherical substrates. In these cases, the adhesive masking tape must undergo neither partial detachment from the substrate nor constriction (necking) at the extended edges, in order to prevent paint underruns and uneven paint edges, respectively. With the adhesive masking tape of the invention, in contrast to the polyolefin adhesive tapes, lateral constriction (necking) is not observed.

A high MD elongation at break of 150% to 300%, in particular from 180% to 250%, is vital to prevent tearing of the adhesive masking tape during application and to permit tearing by hand.

A further characterstic variable is the MD force at 1% elongation (F1%). Here, a minimum figure of 4.5 N/cm, preferably more than 5.5 N/cm, is desirable in order to prevent stretching of the masking tape during unwind and bonding, and especially in the case of automated application, since such stretching can lead to shrinkback during the thermal curing of the paint films.

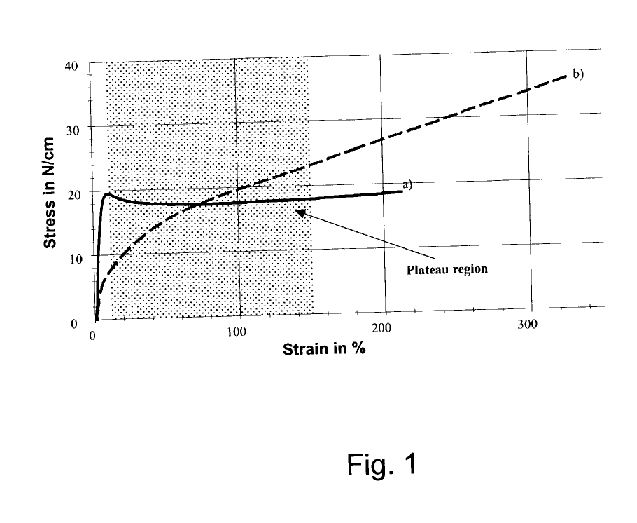

In order to comply with these performance-relevant properties, the adhesive masking tape of the invention possesses a special stress-strain behavior which is characterized by the ratio of the MD tensile force at 1% and 50% elongation in the range from 0.2 to 0.33. This special stress-strain behavior is characterized by a steep rise in force at low elongation, important for preventing stretching of the film on application, and the formation of a force plateau (see FIG. 1) or moderate increase in the range from 12 to 28 N/cm, preferably from 15 to 22 N/cm, above an elongation of 10%, which allows crease-free curve bonding and planar bonding on spherical substrates. This behavior is characterized by the MD force at an elongation of 10% and 150%.

Furthermore, the adhesive masking tape of the invention can be torn off easily by hand, allowing the user to tear it following application without having to apply high force and without the assistance of tools such as scissors or knives. The benefit of this is a considerable time saving in processing. The property of hand tearability is reflected in the tensile impact strength (DIN 53453, ISO/R 179). In order to ensure sufficient tearabilty, the films ought preferably to have a strength of less than 1,000 kJ/m², preferably less than 700 kJ/m², longitudinally with respect to the machine direction.

These requirements demand the use of a backing film having a specific rheological behavior. At low speeds and/or low frequencies (corresponding to application), the adhesive masking tape must behave softly and conformably, and at high speeds and/or high frequencies (corresponding to tearing by hand), its behavior must be hard and brittle. The low-speed behavior is reflected in the stress-strain properties and the high-speed behavior in the tensile impact strength of the backing film. Moreover, curing of the freshly painted surfaces necessitates a thermal treatment, at 110° C. depending on the type of paint used, in some cases even up to 160° C., for 45 minutes. Even after a thermal load of 150° C., preferably 160° C., the adhesive masking tape of the invention can be detached without residue from the paint surface.

These atypical film properties (low extensibility during unwind coupled with ready deformability and curve bondability) of the adhesive masking tape of the invention are best realized by a PVC film, preferably composed of one or more PVC polymers having an average K value of less than 63 (DIN 53726, ISO 174). These film properties can be achieved, for example, by using PVC polymers having a broad or bimolecular molar mass distribution and preferably by blending two PVC polymers of different molecular weight (expressed as the K value) based on emulsion, suspension and/or bulk PVC base materials, especially suspension PVC.

In order to optimize the properties, especially the stress-strain behavior, of the backing film of the adhesive masking tape of the invention, it is preferred to use from 25 to 35 parts by weight, in particular from 30 to 33 parts by weight, of one or more plasticizers per 100 parts by weight of PVC polymer.

In order to prevent residues on the freshly painted surfaces after the removal (demasking) of the adhesive masking tape, and to prevent migration of the plasticizer into the adhesive, preference is given to using nonmigrating plasticizers based on polymers. These plasticizers, known as polymer plasticizers, comprise polyesters based, for example, on adipic, sebacic, azelaic or phthalic acid. In the present invention, plasticizers based on polyadipate esters, such as Palamoll 652 (BASF) or Uraplast RA 19 (DSM), have proved particularly suitable. A description of plasticizers can be found, for example, in Kunststoff-Handbuch—Polyvinylchlorid 2/1 (2nd), Hanser Verlag, section 6.7. The content of that section is hereby incorporated by reference to become part of the present disclosure and invention.

Because of their slight migration, monomer plasticizers based on dicarboxylic esters such as phthalic diesters or tricarboxylic esters such as trimellitic esters, have a tendency toward fogging and the formation of residues. The fraction of monomer plasticizers such as di-2-ethylhexyl phthalate (DOP) or diisononyl phthalate (DINP), for example, should therefore preferably be less than 4 parts by weight, with particular preference less than 1 part by weight, per 100 parts by weight of PVC polymer.

The addition of stabilizers is desirable in order to prevent thermal damage to the PVC films during processing and application. The function of the stabilizers is primarily to prevent embrittlement and discoloration of the PVC backing film in the course of the manufacturing process, processing, and subsequent use. Stabilizers of this kind are described, for example, in Plastics Additives Handbook (5th ed.), Hanser Verlag, section 3 and Kunststoff-Handbuch—Polyvinylchlorid 2/1 (2nd), Hanser Verlag, section 6.3. The content of that section is hereby incorporated by reference and becomes part of this disclosure and invention.

Stabilizers based on barium/zinc, calcium/zinc or tin compounds in particular are suitable for the adhesive masking tape of the invention. The use of stabilizers containing lead or cadmium is likewise possible but tends nowadays to be avoided on toxicological and environmental grounds. The stabilizer content is for example from 2 to 5 parts by weight to 100 parts by weight of PVC polymer.

The additional use of from 1 to 4 parts by weight of epoxidized natural oils (for example, epoxidized soybean oil) as costabilizers is possible although not especially advantageous on account of the migration tendency, which is analogous to that of the monomer plasticizers.

Moreover, the additives customary in the production of PVC films, such as fillers, processing aids, and lubricants, can be used for the backing film of the adhesive masking tape of the invention. Customary additives are described in Kunststoff-Handbuch—Polyvinylchlorid 2/1 (2nd), Hanser Verlag, section 6. The content of said section is hereby incorporated by reference, to become part of this disclosure and invention. In order to optimize the film properties it is likewise possible to use PVC-compatible polymers such as, for example, chlorinated PVC, nitrile butyl rubber, and ethylene-vinyl acetate copolymers. In a further advantageous embodiment of the invention, the film is embossed in order to adjust the unwind force.

The PVC backing material is provided on one side with an adhesive coating. As the coating of adhesive for the adhesive masking tape, polyisoprene, polyisobutylene, and acrylic adhesives are especially suitable. Crosslinking is advantageous to improve the removability of the adhesive masking tape following application, and can be carried out thermally or by irradiation with UV light or electron beams. In order to ensure sufficient adhesion and yet ease of unwind and redetachability following use, the bond strength to steel should be situated within the range from 2.0 to 4.8 N/cm.

If desired, a release varnish may be applied to the reverse in order to enhance the ease of unwind.

The use of a primer layer between backing film and adhesive for the purpose of improving the adhesion of the adhesive to the film and hence enhancing the residueless redetachability following application is advantageous.

Descriptions of the adhesives commonly used for adhesive masking tapes, and also of release varnishes and primers, are given, for example, in Handbook of Pressure Sensitive Adhesive Technology, D. Satas, (3rd ed.). The content of said chapter is hereby incorporated by reference, to become part of this disclosure and invention.

The adhesive masking tape of the invention is outstandingly suitable for meeting the contradictory requirements of ease of extensibility and a high modulus of elasticity. In comparison with the adhesive masking tape of the invention, there is no force plateau of between 10 and 150% elongation, in accordance with FIG. 1, in the case of adhesive masking tapes composed of a PVC backing material in web form which comprises a PVC polymer having a K value of more than 63, generally from 65 to 80, and a mixture of monomer and polymer plasticizer. As compared with the present invention, the elongation at break of these adhesive masking tapes is generally too low and their tensile strength is generally too high.

The adhesive masking tape preferably permits removal without residue when applied to vehicle paints at up to 150° C., preferably up to 160° C.

For specialty applications where increased tensile strength is needed, such as when masking window flanges during the coating process, for example, it is likewise possible to laminate the adhesive masking tape of the invention together with a further adhesive tape, comprising a polyester backing material, for example, prior to application.

The test methods employed in the examples are characterized below.

The stress-strain characteristics of the adhesive masking tape are measured on test specimens of type 2 (test strips 15 cm wide and 150 cm long, clamped length 100 mm) in accordance with DIN EN ISO 527-3/2/300 at a speed of 300 mm/min. The measurements are conducted under test conditions of 23±1° C. and 50±5% relative humidity.

The tensile force at 1% elongation (F1%) is measured on a test strip 15 mm wide and 150 mm long (clamped length 100 mm) in accordance with DIN EN ISO 527-3/2/10 at a speed of 10 mm/min under test conditions of 23±1° C. and 50±5% relative humidity.

In order to determine the temperature stability and the residues following application, adhesive masking tapes 15 mm wide are bonded to a metal panel painted with synthetic-resin test paint (Schwarzlack [black paint], BASF) which are then stored at 150° C. or 160° C. for one hour. Following subsequent heat conditioning at 25° C. and 60° C., respectively, the adhesive masking tape is removed from the paint surface at these temperatures at an angle of 180°. This is followed by visual assessment of the residues on the paint surface in accordance with the following criteria:

(++) no residues or ghosting at all;

(+) slight ghosting;

(−) ghosting or residues;

(−−) severe residues or transfer of adhesive.

The paint adhesion and the quality of the paint edge are tested by painting a metal panel masked in places with the adhesive masking tape. During the painting process, the paint must not fall off in beads from the surface of the tape. After drying and baking of the paint film at 80° C. and subsequent removal of the adhesive masking tape, the tape must not tear and the paint film adhering to it must not flake even on bending and creasing. subsequently, the quality of the paint edge is assessed.

In order to investigate the shrinkage behavior of the masking tapes, test strips 20 cm long are bonded to a test substrate (painted metal panel), fastened at the ends with an adhesive tape, severed in the middle of the strip and stored at 130° C. for 30 minutes. The gap which appears is measured and reported in % relative to the initial length, as a measure of the shrinkage.

The tensile impact strength of the adhesive masking tape is determined in accordance with DIN EN ISO 8256 under test conditions of 23±1° C. and 50±5% relative humidity on samples measuring 15 mm wide and 27 mm long. In the case of the MD tensile impact strength, the test specimens are cut parallel to the machine direction and the crack extends, accordingly, transverse to the machine direction. The figure reported is in each case the arithmetic mean of 10 measurements. In accordance with DIN EN ISO 8256, the tensile impact strength is given by the calculation:

E=E_{c}/(x*d)* 1,000

where

E is tensile impact strength

E_{c} is impact energy

x is sample width

d is sample thickness.

The bond strengths are determined at a peel angle of 180° in accordance with AFERA 4001 on test strips 15 mm wide under test conditions of 23±1° C. and 50±5% relative humidity. The test substrates used here are steel plates.

Below, the invention is illustrated with reference to a number of examples, without wishing thereby to restrict the invention in any way whatsoever. Additionally, comparative examples are given which underline the outstanding properties of the adhesive masking tape of the invention.

### EXAMPLES

### Example 1

In order to produce the backing film first of all a dry blend of

| | | |
|---|---|---|
| 100 | parts by weight | Solvin 258 RF (Solvin) |
| 32 | parts by weight | Palamoll 652 (BASF) |
| 20 | parts by weight | Omya EHX1 (Omya) |
| 4 | parts by weight | Baerostab UBZ 639 (Baerlocher) |
| 2 | parts by weight | Baerostab LSA (Baerlocher) |
| 1.5 | parts by weight | Paraloid K 120 (Rohm and Haas) |

is prepared in a high-speed mixer. The dry blend is subsequently plasticized in an extruder and using a calender is shaped to a film with a width of 2,500 mm and a thickness of 0.08 mm. The backing film is coated with a layer of adhesion promoter, consisting of a solution of 1 part by weight natural rubber and 1 part by weight nitrile rubber in toluene, at an application rate of 0.6 g/m², and dried. The coating of adhesive is applied directly to the adhesion promoter layer at an application rate of 25 g/m² using a comma bar. The adhesive consists of a solution of a natural rubber adhesive in petroleum spirit with a solids content of 30 percent by weight. This solution consists of

| | |
|---|---|
| 50 parts by weight | natural rubber |
| 10 parts by weight | zinc oxide |
| 3 parts by weight | rosin |
| 6 parts by weight | alkylphenol resin |
| 17 parts by weight | terpene-phenolic resin |
| 12 parts by weight | poly-β-pinene resin |
| 2 parts by weight | mineral oil. |

The coating is dried in a drying tunnel at 70° C.

The self-adhesive surface protection film can be unwound without visible extension and when used for masking automobile parts can be applied even to difficult geometries. Even bonding around narrow curves is possible without creases and without lifting of the edge regions. Tearing by hand requires some application of force, which is reflected in a relatively high figure for the tensile impact strength. Following use (painting process), the adhesive masking tape can be removed without problems and without tearing from the bond substrate, and gives a very sharp, even paint edge. When relatively high paint baking temperatures are used (>140° C.), slight deposits (ghosting) on the paint surface are observed.

### Example 2

As in Example 1, a backing film consisting of

| | | |
|---|---|---|
| 100 | parts by weight | Solvin 258 RF (Solvin) |
| 29 | parts by weight | Palamoll 652 (BASF) |
| 1.5 | parts by weight | Palatinol N (BASF) |
| 20 | parts by weight | Omya EHX1 (Omya) |
| 4 | parts by weight | Baerostab UBZ 639 (Baerlocher) |
| 2 | parts by weight | Baerostab LSA (Baerlocher) |
| 1.5 | parts by weight | Paraloid K 120 (Rohm and Haas) |

is produced and is coated with adhesion promoter and adhesive.

The self-adhesive surface protection film can be unwound without elongation and when used for masking automobile parts can be applied flawlessly even on difficult geometries. Following use (painting process) the adhesive masking tape can be removed without problems and without tearing from the bond substrate and produces a very sharp, even paint edge. When relatively high paint baking temperatures are used (>140° C.) slight deposits (ghosting) and residues are observed on the paint surface.

### Example 3

As in Example 1, a backing film consisting of

| | | |
|---|---|---|
| 80 | parts by weight | Solvin 265 PC (Solvin) |
| 20 | parts by weight | Solvin 250 SB (Solvin) |
| 4 | parts by weight | Vinnolit K 221 (Vinnolit) |
| 31 | parts by weight | Palamoll 652 (BASF) |
| 20 | parts by weight | Omya EHX1 (Omya) |
| 4 | parts by weight | Baerostab UBZ 731 (Baerlocher) |
| 1.5 | parts by weight | Paraloid K 120 (Rohm and Haas) |

is produced and is coated with adhesion promoter and with a polyisobutylene adhesive.

The self-adhesive surface protection film can be unwound without creasing and when used for masking automobile parts can be applied flawlessly even to difficult geometries. As a result of the lower tensile force plateau of elongations of between 10 and 150%, particularly good conformability to convex surfaces, and also curved bondability, are ensured. The film is notable for particularly easy hand tearability, without the mechanical properties being adversely affected to the same extent. Following use (painting process), the adhesive masking tape can be removed without problems, residue or tearing from the bond substrate, and produces a very sharp, even paint edge. Even when relatively high paint baking temperatures of from 150 to 160° C. are employed, no deposits (ghosting) whatsoever are observed on the paint surface.

### Example 4

A backing film as in Example 3 is coated with an adhesion promoter coat consisting of a solution of Desmolac (Bayer) in toluene at an application rate of 0.6 g/m² and dried. The adhesive coating is applied directly to the adhesion promoter coat at an application rate of 25 g/m² using a comma bar.

The adhesive consists of a solution of an acrylic adhesive in toluene with a solids content of 40 percent by weight. This adhesive consists of 0.3 part by weight isocyanate and a copolymer of 90 parts by weight n-butyl acrylate and 10 parts by weight hydroxyethyl acrylate. The coating is dried in a drying tunnel at 70° C.

The self-adhesive surface protection film features properties analogous to those of Example 2. However, it is possible to use higher paint baking temperatures of from 160° C. to 170° C. No deposits (ghosting) or residues whatsoever are observed on the paint surface.

Comparison of the properties of the examples:

| | Example 1 | Example 2 | Example 3 | Example 4 |
|---|---|---|---|---|
| Thickness [mm] | 0.09 | 0.085 | 0.095 | 0.095 |
| Tensile strength MD* | 28 | 26 | 18 | 18 |
| [N/cm] | | | | |
| Elongation at break MD* | 260 | 253 | 218 | 218 |
| [%] | | | | |
| Force at 1% MD* | 6.3 | 4.3 | 5.9 | 5.9 |
| [N/cm] | | | | |
| Force at 10% [N/cm] | 15/13 | 13/12 | 19/17 | 19/17 |
| MD/cd* | | | | |
| Force at 150% [N/cm] | 25/15 | 17/15 | 17/19 | 17/19 |
| MD/cd* | | | | |
| Force at 1% MD/force at | 0.22 | 0.23 | 0.31 | 0.31 |
| 50% MD* | | | | |
| Temperature stability at | + | + | ++ | ++ |
| 150° C. | | | | |
| Bond strength, steel | 3.2 | 3.0 | 2.8 | 2.2 |
| [N/cm] | | | | |
| Hand tearability | + | + | ++ | ++ |
| Tensile impact strength | 950/764 | 843/693 | 356/263 | 356/263 |
| MD/cd* [kJ/m²] | | | | |

*MD machine direction
*cd cross direction (transverse to the machine direction)

### Comparative Example 1

As in Example 1, a backing film consisting of

| | |
|---|---|
| 100 parts | Vinnolit H 65 D (Vinnolit) |
| 40 parts | Palatinol AH (BASF) |
| 10 parts | Omya EHX1 (Omya) |
| 4 parts | Baerostab UBZ 639 (Baerlocher) |
| 3 parts | Baerostab LSA (Baerlocher) |

is produced and is coated with adhesion promoter and with adhesive.

In the course of use the adhesive masking tape is stretched to a considerable extent, with the consequence that a considerable shrinkage tendency is observed at elevated temperatures. Tearing by hand is possible only with very high force being applied. Moreover, following use (painting process) the tape cannot be removed without residue from the bond substrate. Complete transfer of the adhesive is observed.

### Comparative Example 2

As in Example 1, a backing film consisting of

| | | |
|---|---|---|
| 100 | parts by weight | Vinnolit S4170 (Vinnolit) |
| 32 | parts by weight | Palamoll 652 (BASF) |
| 20 | parts by weight | Omya EHX1 (Omya) |
| 4 | parts by weight | Baerostab UBZ 639 (Baerlocher) |
| 2 | parts by weight | Baerostab LSA (Baerlocher) |
| 1.5 | parts by weight | Paraloid K 120 (Rohm and Haas) |

is produced and is coated with adhesion promoter and with adhesive.

The adhesive masking tape can be applied flawlessly in use. Under thermal load in the baking process of the paint, only a slight shrinkage tendency is observed. It is, however, not possible to tear the adhesive masking tape by hand. Moreover, following use (painting process) the tape cannot be removed without residue from the bond substrate. Complete transfer of the adhesive is observed.

### Comparative Example 3

As in Example 1, a backing film consisting of

| | | |
|---|---|---|
| 100 | parts by weight | Solvin 265 PC (Solvin) |
| 22 | parts by weight | Palamoll 652 (BASF) |
| 6 | parts by weight | Palatinol N (BASF) |
| 20 | parts by weight | Omya EHX1 (Omya) |
| 4 | parts by weight | Mark 17 M (Akcros Chem.) |
| 2 | parts by weight | Baerostab LSA (Baerlocher) |
| 1.5 | parts by weight | Paraloid K 120 (Rohm and Haas) |

is produced and is coated with adhesion promoter and with adhesive.

The self-adhesive surface protection film can be applied flawlessly in use. When paint baking temperatures around 100° C. are used, first of all residues and deposits and, at higher temperatures (>130° C.), transfer of the adhesive to the paint surface are observed.

### Comparative Example 4

A film consisting of

| | |
|---|---|
| 60 parts by weight | Rexflex W 101 (Huntsman), |
| 40 parts by weight | Escorene 4792 E1 (Exxon) |
| 0.1 part by weight | Irganox 1010 (Ciba) |

is subjected to corona surface treatment and then as in Example 1 is coated with an adhesion promoter coat and with adhesive, and crosslinked.

This adhesive masking tape cannot be applied flawlessly. When bonded in difficult geometries such as narrow curves and edges, constriction (necking) of the adhesive tape occurs. It is impossible to produce clean paint edges. In the course of application, the adhesive masking tape is stretched considerably, since the force at 1% elongation is very low. In addition, inadequate paint adhesion to the reverse film is observed, manifested in flaking of the paint film on removal, and also lifting of the paint edges on storage at elevated temperature is observed, owing to the high shrinkback tendency.

Comparison of the properties of the Comparative Examples:

| | Comparative | Comparative | Comparative | Comparative |
|---|---|---|---|---|
| | Example 1 | Example 2 | Example 3 | Example 4 |
| Thickness | 0.1 | 0.09 | 0.09 | 0.09 |
| [mm] | | | | |
| Tensile | 36 | 31 | 33 | 21 |
| strength MD* | | | | |
| [N/cm] | | | | |
| Elongation at | 335 | 310 | 150 | 580 |
| break MD* [%] | | | | |
| Force at 1% | 1.3 | 6.3 | 2.9 | 1.2 |
| MD* [N/cm] | | | | |
| Force at 10% | 7/6 | 15/13 | 17/15 | 9/7 |
| [N/cm] | | | | |
| MD/cd* | | | | |
| Force at 150% | 23/24 | 27/15 | 25/19 | 17/13 |
| [N/cm] | | | | |
| MD/cd* | | | | |
| Force at 1% | 0.1 | 0.2 | 0.15 | 0.09 |
| MD/Force at | | | | |
| 50% MD* | | | | |
| Temperature | −− | + | + | − |
| stability at | adhesive | | ghosting | shrinkage |
| 150° C. | transfer | | | |
| Bond strength, | 1.1 | 3.2 | 2.5 | 2.7 |
| steel [N/cm] | | | | |
| Hand | −− | + | − | − |
| tearability | | | | |
| Tensile impact | 2265/1930 | 1250/1064 | 1230/1153 | 1843/1550 |
| strength | | | | |
| MD/cd* | | | | |
| [kJ/m²] | | | | |

*MD machine direction
*cd cross direction

FIG. 1 shows comparison of the stress-strain behavior

a) of the adhesive masking tape of the invention (Example 3; ---) and

b) of a conventional PVCp adhesive tape (Comparative Example 1; -----).

What is claimed is:

1. A self-adhesive masking tape for vehicles and vehicle parts, comprising a backing material applied to at least one side of which there is an adhesive coating, wherein said backing material is composed of a material in web form having
an MD tensile force at 1% elongation of at least 4.5 N/cm,
an MD force at an elongation at 10% and 150% of from 12 to 28 N/cm,
an MD tensile strength of from 12 to 30 N/cm, and
an MD elongation at break in the range from 150% to 300%
(MD=machine direction, i.e., longitudinal direction).

2. The tape as claimed in claim 1, wherein the backing film is composed of PVC.

3. The tape as claimed in claim 1, wherein for the material in web form
the MD tensile force at 1% elongation has a value of at least 5.5 N/cm,
the MD elongation at break is in the range from 180% to 250%,
the MD force of an elongation of 10% and 150% has a value in the range from 15 to 22 N/cm and/or
the ratio between the MD force at 1% elongation and at 50% elongation is between 0.2 and 0.33.

4. The tape as claimed in claim 1, wherein for the material in web form the MD tensile impact strength is less than 1,000 kJ/m2, in particular less than 700 kJ/m2.

5. The tape as claimed in claim 1, wherein the average K value of the PVC polymer of the backing film does not exceed a value of 63 and/or the backing film is composed of two PVC homopolymers having different K values.

6. The tape as claimed in claim 1, wherein
the backing film contains from 25 to 35 parts by weight of polymer plasticizer per 100 parts by weight of PVC polymer, in particular from 30 to 33 parts by weight, and/or
the fraction of monomer plasticizer in the backing film is less 4 parts by weight per 100 parts by weight of PVC polymer, in particular less than 1 part by weight per 100 parts by weight of PVC polymer.

7. The tape as claimed in claim 1, wherein residueless removal on application at up to 150° C., preferably up to 160° C., on vehicle paints is possible.

8. The tape as claimed in claim 1, composed of a backing film coated with a self-adhesive composition based on polyisoprene, polyisobutylene or polyacrylate.

9. The tape as claimed in claim 1, wherein the bond strength is in the range from 2.0 to 4.8 N/cm.

10. The tape as claimed in claim 1, wherein the backing film is coated with a coat of primer and adhesion promoter.

11. The tape as claimed in claim 1, which is laminated together with a further adhesive tape, in particular a tape comprising a polyester backing material.

12. The method of using an adhesive masking tape as claimed in claim 1 for masking when painting vehicles and vehicle parts
